(19) United States
(12) Patent Application Publication
(10) Pub. No.: US 2011/0187356 A1
(43) Pub. Date: Aug. 4, 2011

(54) RESOLVER UNIT

(76) Inventors: Chi-Lu LI, Taichung City (TW); Chih-Yu Wang, Taichung City (TW); Shun-Hsing Hsiao, Taichung City (TW); Hsiang-Ju Wang, Taichung City (TW); Chin-Chia Liu, Taichung City (TW)

(21) Appl. No.: 12/698,396

(22) Filed: Feb. 2, 2010

(51) Int. Cl. G01B 7/30

(52) U.S. Cl. 324/207.25

(57) ABSTRACT

A resolver unit including a first resolver and a second resolver. The first resolver includes a first rotor. A certain number of first rotor magnetic poles are annularly disposed on the first rotor at equal intervals. The second resolver includes a second rotor coaxial with the first rotor. A certain number of second rotor magnetic poles are annularly disposed on the second rotor at equal intervals. The number of the second rotor magnetic poles is different from the number of the first rotor magnetic poles.

### BACKGROUND OF THE INVENTION

The present invention relates generally to motor position sensing technique, and more particularly to a resolver unit.

A resolver is an angular displacement sensor for outputting voltage in a fixed function relationship to the rotational angle of a rotor. In comparison with the conventional optical ruler, magnetic ruler, Hall element and rotary photoelectric encoder, the resolver has the advantages of low price, good environmental durability and high resolution. Therefore, various resolvers have been widely used as position feedback devices for rotary motors.

The resolver is composed of a rotor and a stator. In general, the rotor is simply formed with splines, while the stator is formed with splines on which excitation coils and induction coils are wound. The excitation coils serve as the excitation signal sources. The induction coils serve to sense the change of magnetic field resulting from relative motion between the stator and the rotor and output amplitude modulation signal. The amplitude modulation signal is then resolved by means of a circuit to obtain position data.

U.S. Pat. No. 7,467,456 of this applicant discloses a high-resolution resolver. However, the conventional resolvers including the high-resolution resolver of the above Patent all output relative signal. Therefore, each time the resolver is started, it is necessary to zero the resolver for having a reference to control the mechanical degree. This leads to delay, inconvenience and troublesomeness in use of the resolver, especially in use of multiaxial actuation mechanism.

### SUMMARY OF THE INVENTION

It is therefore a primary object of the present invention to provide a resolver unit, which can provide true corresponding position data of a motor on the basis of the sensed signal without any zeroing procedure.

To achieve the above and other objects, the resolver unit of the present invention includes a first resolver and a second resolver. The first resolver includes a first rotor. A certain number of first rotor magnetic poles are annularly disposed on the first rotor at equal intervals. The second resolver includes a second rotor coaxial with the first rotor. A certain number of second rotor magnetic poles are annularly disposed on the second rotor at equal intervals. The number of the second rotor magnetic poles is different from the number of the first rotor magnetic poles.

The present invention can be best understood through the following description and accompanying drawings, wherein:

### BRIEF DESCRIPTION OF THE DRAWINGS

FIG. 1 is a perspective exploded view of a preferred embodiment of the present invention;

FIG. 2 is a perspective assembled view of the preferred embodiment of the present invention;

FIG. 3 is a front view of the preferred embodiment of the present invention;

FIG. 4 is a rear view of the preferred embodiment of the present invention; and

FIGS. 5A to 5D are graphs of linear function of the electrical signals after processed according to the preferred embodiment of the present invention.

### DETAILED DESCRIPTION OF THE PREFERRED EMBODIMENTS

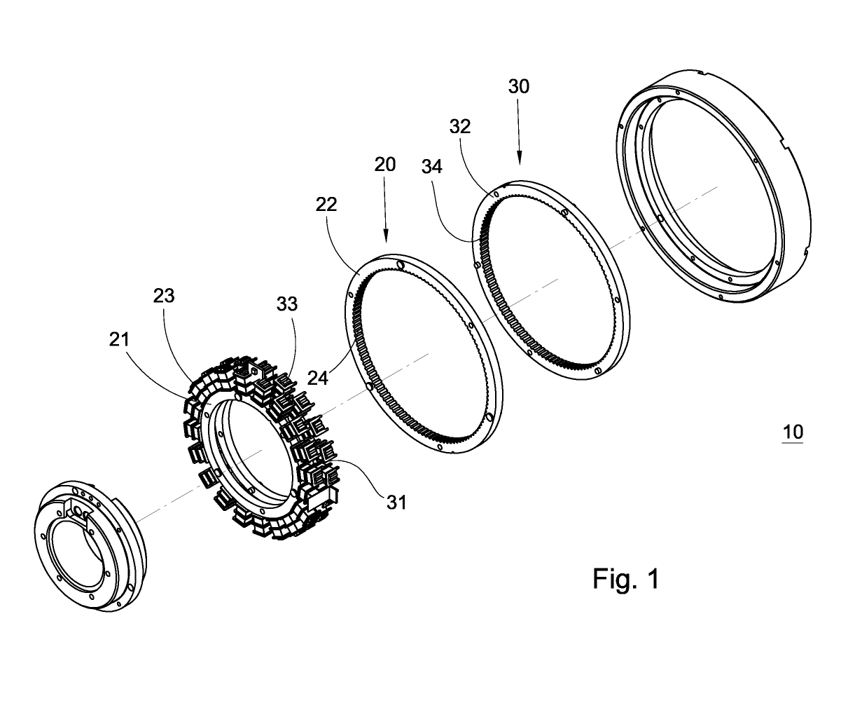

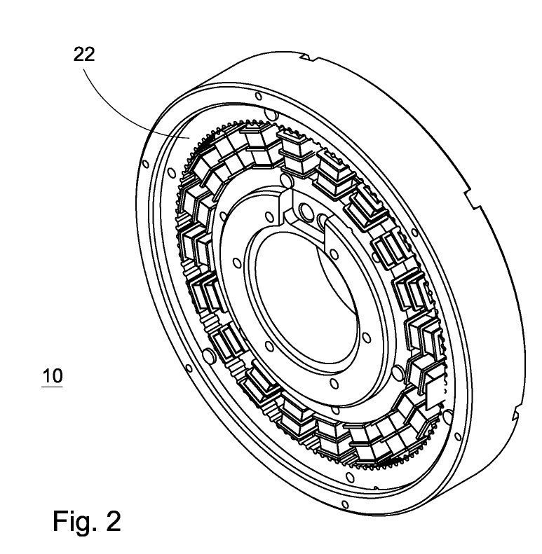

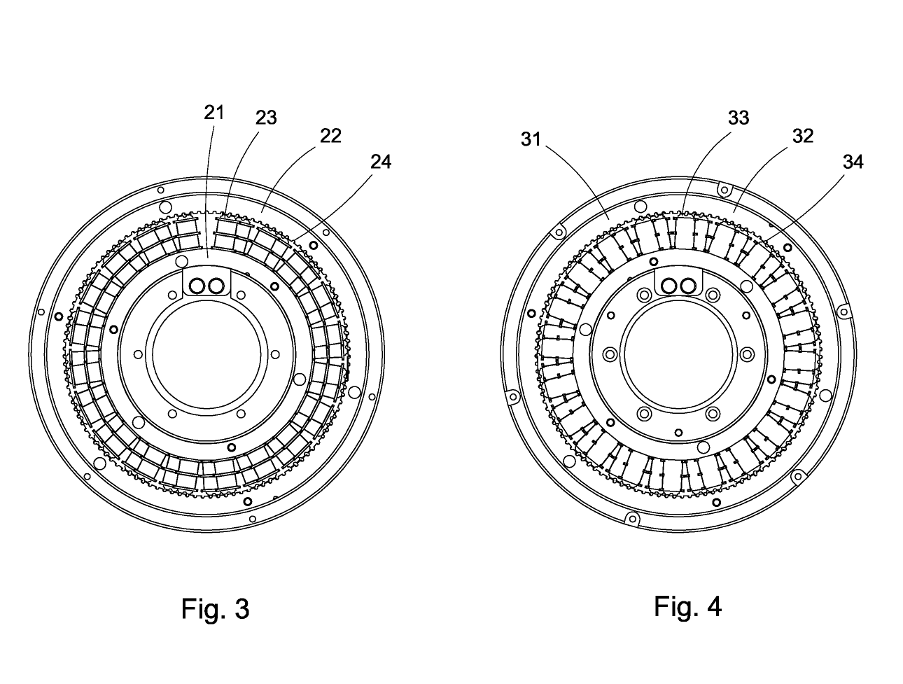

Please refer to FIGS. 1 to 4 and 5A to 5D. According to a preferred embodiment, the resolver unit 10 of the present invention includes a first resolver 20, a second resolver 30 and a digital signal processor (DSP). The resolvers 20, 30 can be, but not limited to, conventional outer rotor reluctance resolvers.

Substantially, the resolvers 20, 30 are coaxially installed on a shaft of a rotary motor and spaced from each other for measuring angular displacement of the rotary motor. The resolvers 20, 30 serve to respectively output amplitude modulation signals for the digital signal processor (not shown) to convert analog signals into digital signals. Then the digital signals are resolved through an angle resolution process.

To speak more specifically, the first resolver 20 includes a first stator 21 and a first rotor 22 coaxial therewith. The second resolver 30 includes a second stator 31 and a second rotor 32 coaxial therewith. The first rotor 22 is also coaxial with the second rotor 32. A certain number of first stator magnetic poles 23 are disposed on an outer circumference of the first stator 21 at equal intervals. A certain number of first rotor magnetic poles 24 are disposed on an inner circumference of the first rotor 22 at equal intervals. A certain number of second stator magnetic poles 33 are disposed on an outer circumference of the second stator 31 at equal intervals. A certain number of second rotor magnetic poles 34 are disposed on an inner circumference of the second rotor 32 at equal intervals.

The numbers of the first and second stator magnetic poles 23, 33 and the numbers of the first and second rotor magnetic poles 24, 34 are determined by the following formula:

$${N}_{s} \times [ ( \frac{q + 1}{q} ) + ( n \pm \frac{k}{2} ) ] = {N}_{r} , wherein \text{:}$$

Nₛ: number of stator magnetic poles;
Nᵣ: number of rotor magnetic poles:
q: phase number;
n: span between rotor magnetic poles; and
±k: buffer distance between stator magnetic poles.

In the above formula, the number of stator magnetic poles (Nₛ) must be an integer multiple (t) of the phase number (q).

The resolver unit of the present invention is characterized in that the number of the first rotor magnetic poles 24 of the first resolver 20 and the number of the second rotor magnetic poles 34 of the second resolver 30 are prime to each other. Preferably, the difference between the first rotor magnetic poles 24 and the number of the second rotor magnetic poles 34 is 1. More preferably, the number of the first rotor magnetic poles 24 is, but not limited to, 115, while the number of the second rotor magnetic poles 34 is, but not limited to, 114. For example, alternatively, the number of the first rotor magnetic poles 24 and the number of the second rotor magnetic poles 34 can be 120 and 119 respectively.

The signal of angular displacement of the rotary motor measured by the resolvers 20, 30 are input to the digital signal processor for processing the signal through the angle resolution process. To speak more specifically, the angle resolution process includes steps of:
a. converting analog signal into digital signal and processing the digital signal:

The sine signals and cosine signals input by the resolvers 20, 30 are converted into electrical degree β according to the following formula:

$${tan}^{- 1} ( \frac{sin}{cos} )$$

The number of electrical signal periods per cycle of rotation of the rotor is equal to the number of the rotor magnetic poles. That is, in the case that there are 115 electrical signal periods (sx, x=1˜115) per cycle of rotation of the first rotor 22, the mechanical degree a corresponding to each period (sx) is 360/115. In the meantime, in the case that there are 114 electrical signal periods (s′ x, x=1˜114) per cycle of rotation of the second rotor 32, the mechanical degree a corresponding to each period (s′ x) is 360/114. Also, the electrical degree β corresponding to the electric signal generated by the rotor during each cycle ranges from 0 to 360 degrees.

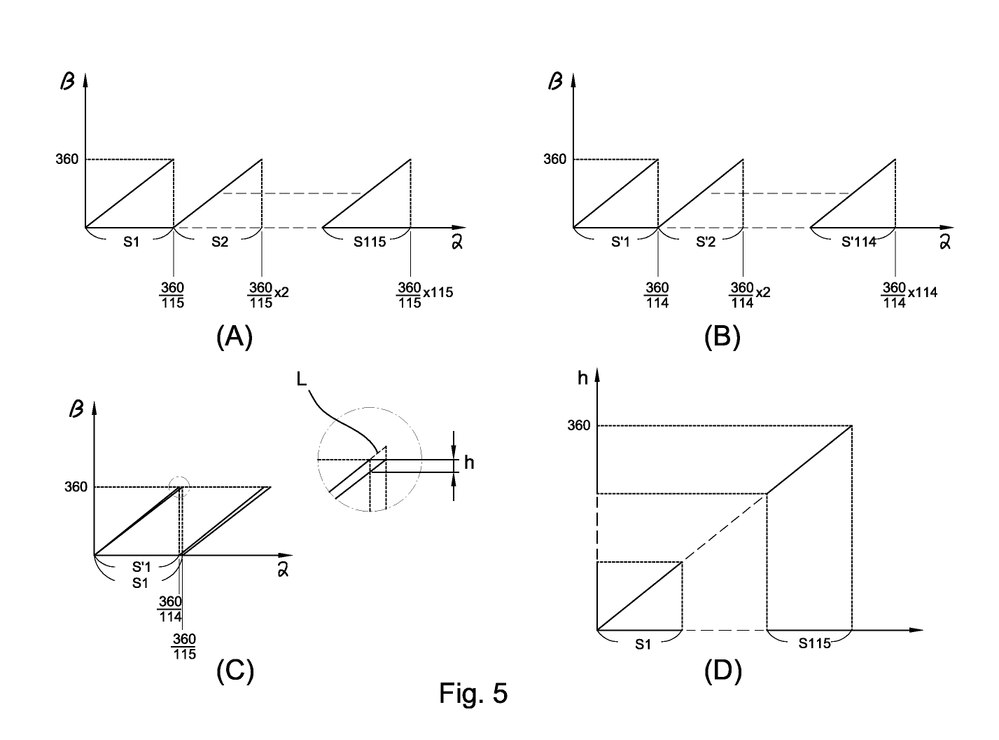

Accordingly, with the mechanical degree α as X-coordinate and electrical degree β as Y-coordinate, FIGS. 5A and 5B show the graphs of the linear function of the electrical signals generated during rotation of the first and second rotors.
b. overlapping and subtracting the periodic signals of the resolvers 20, 30 obtained in step a:

As shown in FIG. 5C, the periodic signals of the resolvers 20, 30 are subtracted from each other to obtain a difference h in Y-coordinate. When the first rotor 22 starts going to the next period from the last period, the second rotor 32 is still in the last period. Therefore, in operation, before the second rotor 32 goes to the next period, the constant of 360 is added to the signal value of the first rotor 22 that has gone to the next period. The corresponding graph is the dotted line L as shown in FIG. 5C.
c. obtaining data of an absolute mechanical degree:

As shown in FIG. 5D, a specific electrical signal period (sx) of the first rotor 22 is judged with the difference h. On the basis of the specific electrical signal period (sx), the corresponding mechanical degree α is pointed with the obtained electrical degree β to obtain the data of the absolute mechanical degree.

In the above resolution process, the first rotor with more periods serves as the basis for the resolution. However, alternatively, the second rotor with less number of periods can also serve as the basis for the resolution. The data obtained are all absolute mechanical angles and need no zeroing or rectification procedure.

In the resolver unit 10 of the present invention, the two resolvers 20, 30 have different numbers of rotor magnetic poles. A specific period can be judged with the difference between different periodic signals in one cycle. Then the absolute mechanical degree is pointed on the basis of the specific period. Therefore, the data obtained are absolute angle values and it is no more necessary to obtain comparative reference value through the zeroing procedure as in the prior art. In other words, during each electrical signal period, the signal of one rotor serves as the comparison reference of the other rotor to immediately obtain true data of the absolute mechanical degree even in a condition of restart.

In the above embodiment, the resolvers are reluctance resolvers. However, any other type of angle sensor that is able to generate regular periodic signals can be selectively used as the resolvers of the present invention. Different types of resolvers can be selectively applied to different environments in accordance with different technical demands.

The above embodiments are only used to illustrate the present invention, not intended to limit the scope thereof. Many modifications of the above embodiments can be made without departing from the spirit of the present invention.

What is claimed is:

1. A resolver unit comprising:
a first resolver including a first rotor, a certain number of first rotor magnetic poles being annularly disposed on the first rotor at equal intervals; and
a second resolver including a second rotor coaxial with the first rotor, a certain number of second rotor magnetic poles being annularly disposed on the second rotor at equal intervals, the number of the second rotor magnetic poles being different from the number of the first rotor magnetic poles.

2. The resolver unit as claimed in claim 1, wherein the number of the first rotor magnetic poles of the first resolver and the number of the second rotor magnetic poles of the second resolver are prime to each other.

3. The resolver unit as claimed in claim 2, wherein the difference between the first rotor magnetic poles and the number of the second rotor magnetic poles is 1.

4. The resolver unit as claimed in claim 1, wherein the difference between the first rotor magnetic poles and the number of the second rotor magnetic poles is 1.

5. The resolver unit as claimed in claim 1, wherein the number of the first rotor magnetic poles is 114, while the number of the second rotor magnetic poles is 115.

6. The resolver unit as claimed in claim 1, wherein the resolvers are reluctance resolvers.
